(19) United States
(12) Patent Application Publication
(10) Pub. No.: US 2025/0174019 A1
(43) Pub. Date: May 29, 2025

(54) ROAD CRACK DETECTION METHOD, MEDIUM AND PRODUCT

(71) Applicant: Nanjing University of Posts and Telecommunications, Nanjing (CN)

(72) Inventors: Dengyin ZHANG, Nanjing (CN); Jiahui ZHU, Nanjing (CN)

(21) Appl. No.: 19/037,226

(22) Filed: Jan. 26, 2025

Related U.S. Application Data
(63) Continuation of application No. PCT/CN2025/070526, filed on Jan. 3, 2025.

(30) Foreign Application Priority Data
Jul. 23, 2024 (CN) 202410987176.4

(51) Int. Cl. G06V 10/82; G06T 7/00; G06V 10/766; G06V 10/774; G06V 10/778

(52) U.S. Cl. CPC G06V 10/82; G06T 7/0002; G06V 10/766; G06V 10/774; G06V 10/778; G06T 2207/20081; G06T 2207/20084; G06T 2207/30184

(57) ABSTRACT

Provided is a road crack detection method, a medium and a product. The lightweight YOLO-MCS road crack detection model is constructed based on an improved yolov8 network. A method of improving the yolov8 network includes: replacing a feature extraction network backbone with a lightweight convolutional neural network MobileNetV3, and embedding a Coordinate Attention Mechanism (CA) module in the lightweight convolutional neural network MobileNetV3; adding a small target detection layer and a Squeeze and Excitation (SE) module at a neck end; and introducing a loss function of power Intersection over Union (IoU) into a head prediction structure. The road crack detection method overcomes the problem that the existing detection algorithm has low detection precision for small cracks and is difficult to be applied to edge devices with limited computing resources.

### TECHNICAL FIELD

The present disclosure relates to a road crack detection method, a medium and a product, and belongs to the technical field of computer vision.

### BACKGROUND

The operating efficiency, the reliability and the safety of public roads and transportation systems are important supports for social development. At present, highways in China are facing severe challenges such as population growth, infrastructure degradation, and rapid increase in construction and maintenance costs. A crack is a common pavement disease. If left unattended, small cracks will develop into larger cracks. For example, if not detected in time, cracks on public roads will further expand in rainy weather, which will bring great harm to driving safety. Therefore, it is particularly important to find and repair cracks in time.

The mileage of highways in China has exceeded 5.35 million kilometers. If manual detection is still used, the test process is complicated, the missed detection rate is high, and the timely effect is poor. However, the automatic detection technology can reduce the cost and can be more real-time while ensuring the test precision. In addition, the repair of small cracks is relatively easy and low-cost. Therefore, it is one of the important requirements for automatic detection methods to detect small cracks. At the same time, the continuity of cracks will be affected by the road texture, the natural environment and so on, such as shelter from light shadow, rainy and foggy days, etc. In this case, the contrast between the cracks and the background will be reduced, and it will be more difficult to identify the cracks. Therefore, the automatic detection method must also have good anti-noise ability.

The traditional image processing technology usually uses manually selected features, such as color, texture and geometric features, to segment pavement defects, and then uses a machine learning algorithm for classification and matching to detect pavement cracks. However, due to the complexity of the road environment, the traditional image processing methods cannot meet the requirements of model generalization ability and robustness in practical engineering through manually designed feature extraction. Compared with the traditional image processing technology, an image processing technology based on a deep learning theory does not need to extract features manually, and has higher precision, faster speed, better anti-noise ability and embeddability, which has been widely applied in pavement defect detection.

At present, there are mainly two categories of target detection algorithms based on deep learning. The first category of target detection algorithms is based on the classification method after generating candidate regions, such as Regions with Convolutional Neural Network (CNN) features (R-CNN) and Fast R-CNN. The second category of target detection algorithms is a single-stage detection method, which directly predicts the categories and the bounding boxes of all targets in the image, such as You Only Look Once (YOLO) series, a Single Shot Multi-Box Detector (SSD), etc. Compared with other single-stage detection methods, the yolov8 network stands out with the advantages of high speed, simplicity, global receptive field and multi-scale fusion, and is especially suitable for scenes that require high efficiency and real-time performance. However, the yolov8 network still faces the problems of low detection precision for small objects such as small cracks, a large number of training parameters and difficulty in convergence, and needs further optimization.

The information disclosed in the background section is only intended to increase the understanding of the general background of the present disclosure, and should not be taken as an admission or any form of suggestion that the information forms the prior art that is known to those skilled in the art.

### SUMMARY

The technical problem to be solved by the present disclosure is how to overcome the problem that the existing detection algorithm has low detection precision for small cracks and is difficult to be applied to edge devices with limited computing resources.

In order to solve the above technical problem, the present disclosure is realized by using the following technical scheme.

In a first aspect, the present disclosure provides a road crack detection method, including:
acquiring a road crack image to be detected;
inputting the road crack image into a pre-trained lightweight You Only Look Once (YOLO)-MCS road crack detection model to obtain a road crack detection result;
wherein the lightweight YOLO-MCS road crack detection model is constructed based on an improved yolov8 network;
a method of improving the yolov8 network includes:
replacing a feature extraction network backbone of the yolov8 network with a lightweight convolutional neural network MobileNetV3, and embedding a Coordinate Attention Mechanism (CA) module in the lightweight convolutional neural network MobileNetV3;
adding a small target detection layer and a Squeeze and Excitation (SE) module at a neck end of the yolov8 network;
introducing a loss function of power Intersection over Union (IoU) into a head prediction structure of the yolov8 network to replace a bounding box regression loss function bbox_loss.

Further, prior to inputting a road crack data set into the pre-trained lightweight YOLO-MCS road crack detection model, a data preprocessing operation needs to be performed on the road crack data set.

Further, the specific step of performing data preprocessing operation on the road crack data set includes:
filtering road crack images in the road crack data set to obtain a labeled picture data set containing four different road crack types;
reducing the application of default parameters of scale, mosaic, mixup and paste_in image enhancement methods, introducing shear and perspective image enhancement methods to perform image enhancement processing on the labeled picture data set containing four different road crack types, and obtaining the road crack data set after image enhancement;
normalizing and standardizing the road crack data set after image enhancement to obtain the road crack data set after data scaling;
dividing the road crack data set after data scaling into a training set and a verification set randomly.

Further, a Coordinate Attention Mechanism (CA) module is embedded in the lightweight convolutional neural network MobileNetV3, and an input feature map is expanded by the Coordinate Attention Mechanism (CA) module to obtain an output feature map with expanded spatial information.

Further, the method of expanding an input feature map by the Coordinate Attention Mechanism (CA) module to obtain an output feature map with expanded spatial information includes:
(1) performing pooling in a horizontal direction and a vertical direction of the input feature map, respectively, to obtain one-dimensional perceptual attention feature maps in the X direction and in the Y direction;
(2) after cascading the perceptual attention feature maps in the X direction and in the Y direction, inputting the perceptual attention feature maps into a 1×1 convolution F for transformation to generate an intermediate feature map o containing spatial information in the horizontal direction and in the vertical direction;
(3) decomposing the intermediate feature map o into a tensor o^{h} ∈R^{C/r×H×1} and a tensor o^{w}∈R^{C/r×1×W} along a spatial dimension, and then transforming a tensor o^{h} and a tensor o^{w} into a tensor with the same number of channels as the input features by using two 1×1 convolutions Fₕ and F_{w}, and obtaining a two-dimensional attention map;
(4) expanding the two-dimensional attention map to obtain an output feature with expanded spatial information.

Further, the output feature with expanded spatial information are expressed as:

$${y}_{c ( i , j )} = {x}_{c} ( i , j ) \times {g}_{c}^{h} ( i ) \times {g}_{c}^{w} ( j ) ;$$

where y_{c(i,j)} denotes a value of the output feature map in a channel c with position (i, j), x_{c}(i, j) denotes a value of the input feature map in the channel c with position (i, j), g_{c}^{h}(i) denotes an attention weight of an attention vector g^{h} in the channel c in a horizontal position i, and g_{c}^{w}(j) denotes an attention weight of an attention vector g^{w} in the channel c in a vertical position j.

Further, the method of adding a small target detection layer and a Squeeze and Excitation (SE) module at a neck end of the yolov8 network includes:
(1) reserving the Path Aggregation Network with Feature Pyramid Network (PAN-FPN) structure at the neck end of the yolov8 network, and adding a Squeeze and Excitation (SE) module after the upsample structure at the neck end to cooperate with the added small target detection layer;
(2) accumulating the 80×80 scale feature layer at a feature extraction network backbone end and the upsample feature layer at the neck end, and obtaining fused feature maps of feature information at different scales and different levels;
(3) performing a convolution module C2f, a Squeeze and Excitation (SE) module and an upsample operation on the fused feature maps of feature information at different scales and different levels to obtain a deep semantic feature layer containing small target feature information;
(4) accumulating the deep semantic feature layer containing small target feature information and a shallow position feature layer in the feature extraction network backbone to obtain a feature representation containing rich semantic information and position information;
(5) adding an extra decoupling header at the head end of the yolov8 network as a small target detection layer for detecting small targets.

Further, the power IoU loss function performs uniform exponentiation on the existing loss functions in the yolov8 by introducing an area of a minimum enclosing rectangle of a real box and a predicted box as a parameter, and the power IoU loss function includes an improved IoU loss function α-IoU, an improved GIoU loss function α-GIoU, an improved DIoU loss function α-DIoU and an improved CIoU loss function α-CIoU.

In a second aspect, the present disclosure provides a computer-readable storage medium, on which a computer program/instruction is stored, wherein the computer program/instruction, when executed by a processor, implements the steps of the method.

In a third aspect, the present disclosure provides a computer program product, including a computer program/instruction, wherein the computer program/instruction, when executed by a processor, implements the steps of the method.

Compared with the prior art, the present disclosure has the following beneficial effects.

The lightweight YOLO-MCS road crack detection model proposed by the present disclosure significantly reduces the amount of calculation and the number of network parameters required for detecting road cracks, and enhances the ability to extract the features of small target road cracks, so that road cracks can be detected and identified efficiently and accurately, and the problems that the existing road cracks have diverse shapes and have low differentiation from road surface texture and it is difficult for the existing detection algorithms to be applied to edge devices with limited computing resources are overcome.

### BRIEF DESCRIPTION OF THE DRAWINGS

FIG. 1 is a schematic flow chart of a method of constructing a lightweight YOLO-MCS road crack detection model according to an embodiment of the present disclosure.

FIG. 2 is a schematic diagram of a network architecture of a lightweight YOLO-MCS road crack detection model according to an embodiment of the present disclosure.

FIG. 3 is a schematic diagram of a network structure in which a Coordinate Attention Mechanism (CA) module is embedded in a lightweight convolutional neural network MobileNetV3 according to an embodiment of the present disclosure.

### DETAILED DESCRIPTION OF THE EMBODIMENTS

The technical scheme of the present disclosure will be described in detail through the attached drawings and the detailed description hereinafter. It should be understood that the embodiments of the present disclosure and the specific features in the embodiments are detailed descriptions of the technical scheme of the present disclosure, rather than limitations of the technical scheme of the present disclosure. The embodiments of the present disclosure and the technical features in the embodiments can be combined with each other without conflict.

### Embodiment 1

This embodiment introduces a road crack detection method, including the following steps:
acquiring a road crack image to be detected;
inputting the road crack image into a pre-trained lightweight YOLO-MCS road crack detection model to obtain a road crack detection result;
wherein the lightweight YOLO-MCS road crack detection model is constructed based on an improved yolov8 network.

A method of improving the yolov8 network includes:
replacing a feature extraction network backbone of the yolov8 network with a lightweight convolutional neural network MobileNetV3, and embedding a Coordinate Attention Mechanism (CA) module in the lightweight convolutional neural network MobileNetV3;
adding a small target detection layer and a Squeeze and Excitation (SE) module at a neck end of the yolov8 network;
introducing a loss function of power Intersection over Union (IoU) into a head prediction structure of the yolov8 network to replace a bounding box regression loss function bbox_loss.

According to the present disclosure, the feature extraction backbone network of the yolov8 is replaced with an improved lightweight convolutional neural network MobileNetV3, so that the number of parameters and the amount of calculation are reduced, and the loss of low-dimensional feature information can be reduced. In addition, a Coordinate Attention (CA) mechanism containing precise location information is embedded in the original Squeeze and Excitation (SE) module of MobileNetV3 to form an attention mechanism module fused with precise spatial information, which helps the lightweight YOLO-MCS road crack detection model extract more semantic information from road crack images and reduce unnecessary computational complexity, thus improving the efficiency of the detection algorithm.

The lightweight YOLO-MCS road crack detection model according to the present disclosure mainly solves the problem that the crack target accounts for a low proportion in the image because of the long shooting distance, small cracks and the like. Because the original yolov8 network cannot accurately identify the feature information when the height and the width of the target are both less than 8 pixels, a small target detection layer is added on this basis, so that the lightweight YOLO-MCS road crack detection model can pay more attention to the detection of small target road cracks and improve the detection effect. At the same time, a Squeeze and Excitation (SE) module is added after the upsample structure. In cooperation with the added small target detection layer, the lightweight YOLO-MCS road crack detection model is more efficient and fast in the detection process.

In addition, the present disclosure also replaces the loss function of the original yolov8 network with the loss function of power IoU, which can improve the training effect of the bounding box regression and improve the convergence speed and the regression precision.

### Embodiment 2

This embodiment introduces a road crack detection method, including:
inputting the road crack image containing transverse cracks, longitudinal cracks, crocodile cracks and road potholes into a pre-trained lightweight YOLO-MCS road crack detection model to obtain a road crack detection result.

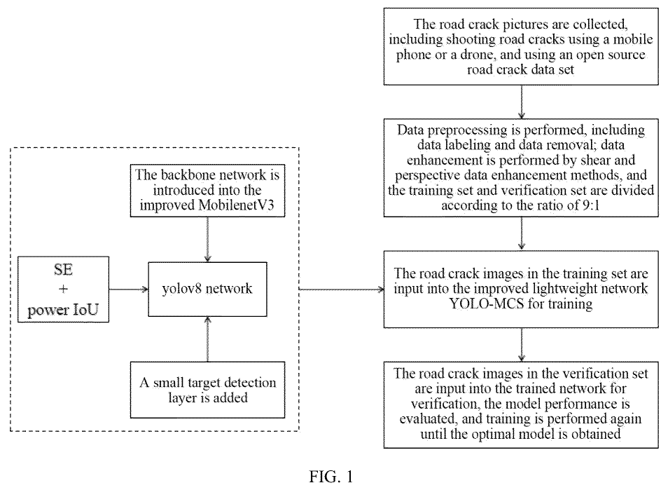

As shown in FIG. 1, the method of constructing a lightweight YOLO-MCS road crack detection model includes the following steps.

Step 1: the road crack image containing one or more road cracks such as transverse cracks, longitudinal cracks, crocodile cracks and road potholes is acquired to construct a road crack data set.

The road crack data set can be constructed by shooting road cracks using a smartphone camera or a drone and collecting road crack images including transverse cracks, longitudinal cracks, crocodile cracks and road potholes, or an open source road crack data set is used.

This embodiment uses the published RDD2022 road injury data set as the road crack data set.

The RDD2022 road injury data set contains training and test road injury images of six countries/regions, including Japan, India, Czech Republic, Norway, USA and China, in which there are 34,702 ground truth labels which include boundary boxes and injury types.

In this embodiment, a computer is selected as an image identification processing terminal. The processor is configured as i9-12900H CPU. The operating system is configured as 64-bit Windows S11. The graphics processing unit GPU is configured as NVIDIA RTX3060Ti.

Step 2: data preprocessing is performed on the road crack data set to be divided into a training set a verification set.

The specific steps of performing data preprocessing on the road crack data set are as follows.

Step 2.1: road crack images in the road crack data set are filtered to obtain a labeled picture data set containing four different road crack types.

Because there is a serious imbalance between different categories of data sets selected in this embodiment, 4,378 training and test data from China in the RDD2022 road injury data set are selected.

The crack category of the unlabeled road crack images is labelled using a labeling tool. The labeled data unrelated to road cracks is removed. At the same time, the labels with very few tags are removed: longitudinal splicing seams (D01), transverse splicing seams (D11), labels unrelated to road cracks (D43), white line blur (D44), manhole covers (D50), etc. Only four categories of cracks such as transverse cracks, longitudinal cracks, crocodile cracks and road potholes are reserved.

Finally, four labeled pictures of different types of road cracks are filtered: longitudinal cracks (D00), transverse cracks (D10), crocodile cracks (D20) and road potholes (D40).

Step 2.2: image enhancement is performed on the labeled picture data set containing four different road crack types, and the road crack data set after image enhancement is obtained.

In order to optimize the performance of the lightweight YOLO-MCS road crack detection model in dealing with road injury detection tasks, first, image enhancement processing is performed on the labeled picture data set containing four different road crack types finely.

In the process of image enhancement processing, the application of default parameters of traditional image enhancement methods such as scale, mosaic, mixup and paste_in is reduced.

Shear and perspective image enhancement methods are introduced to perform image enhancement processing on the labeled picture data set containing four different road crack types.

The application of default parameters of traditional image enhancement methods such as scale, mosaic, mixup and paste_in is reduced, which avoid the changes in the size and shape of road cracks and the introduction of unnatural boundaries and textures that may be resulted from the operations of scale, mosaic, mixup and paste_in, and avoid destruction of continuous information on the road surface. At the same time, this also ensures that the enhanced image can still truly reflect the actual situation of the road injury, which provides valuable information for learning the subsequent lightweight YOLO-MCS road crack detection model.

Shear and perspective image enhancement methods are introduced to perform image enhancement processing on the labeled picture data set containing four different road crack types, in order to further improve the adaptability of the lightweight YOLO-MCS road crack detection model to the complex road conditions and the visual angle changes. The lightweight YOLO-MCS road crack detection model can simulate the visual angle changes or shelter resulted from changes in vehicle speed, road conditions and light conditions, so that the training data is closer to the complex scenes in actual road detection.

Step 2.3: the road crack data set after image enhancement is normalized and standardized to obtain the road crack data set after data scaling.

The road crack data set after image enhancement is normalized.

The road crack data set after the whole image enhancement is traversed. The maximum value or the minimum value of each pixel channel of each image in the road crack data set is calculated. Each pixel value is normalized through the maximum value or the minimum value. The original pixel value is replaced with the normalized pixel value to obtain the normalized road crack data set.

The normalized road crack data set is standardized. The road crack data set after the whole image enhancement is traversed. The mean value and the standard deviation of each pixel channel of each image in the road crack data set is calculated. Each pixel value is standardized by subtracting the mean value and dividing the result by the standard deviation. The original pixel value is replaced with the standardized pixel value to obtain the road crack data set after data scaling.

Normalization reduces the absolute difference of pixel values, while standardization further smoothens the distribution of data, which helps the lightweight YOLO-MCS road crack detection model learn image features better.

Step 2.4: the road crack data set after data scaling is divided.

In this embodiment, the road crack data set after data scaling is randomly divided into a training set and a verification set according to the ratio of 9:1.

Step 3: the lightweight YOLO-MCS road crack detection model is constructed.

The lightweight YOLO-MCS road crack detection model provided by the present disclosure is constructed based on the improved yolov8 network. The method of improving the yolov8 network includes the following steps.

Step 3.1: a feature extraction network backbone of the yolov8 network is replaced with a lightweight convolutional neural network MobileNetV3.

The lightweight convolutional neural network MobileNetV3 replaces the conventional convolution operation with the deep separable convolution, which reduces the number of parameters and the amount of calculation. At the same time, the linear bottleneck structure embedded with a reverse residual structure is used to extract features, which can reduce the loss of low-dimensional feature information. The channel attention mechanism is also embedded, which can enhance the channel feature selection ability.

The depth separable convolution divides the conventional convolution operation into depth convolution and pointwise convolution, applies a single convolution kernel for each input channel to obtain the uncorrelated features of each channel, and then uses pointwise convolution to correlate the features of each channel output by depth convolution.

In the deep convolution, the convolution operation is performed on each input channel separately, instead of mixing all input channels together like standard convolution. If there are C channels for input, the depth convolution will generate C different feature maps, and each feature map corresponding to one input channel. Because the weight of each channel is only related to itself, rather than to all channels, the number of parameters is reduced.

Pointwise convolution, also referred to as 1×1 convolution, is a special type of convolution, and its size of the convolution kernel is 1×1. In the pointwise convolution, T feature maps generated by deep convolution are combined together, and the depth of the lightweight convolutional neural network MobileNetV3 is increased by pointwise multiplication. Pointwise convolution allows the lightweight convolutional neural network MobileNetV3 to increase the network capacity without changing the width and the height of the feature map.

It is assumed that the dimension of the input feature is D_{f}×D_{f}×M, the size of the convolution kernel is Dₖ×Dₖ, and the dimension of the output feature is D_{f}×D_{f}×N, where M and N denote the number of input channels and the number of output channels, respectively, D_{f} denotes the spatial dimension of the input and output feature maps, f denotes a height value of the feature map and a width value of the feature map, Dₖ denotes the size of the convolution kernel, and k denotes a height value and a width value of the convolution kernel.

The expression of the ratio of the amount of calculation between the depth separable convolution and the standard convolution is expressed as:

$$\frac{{C}_{2}}{{C}_{1}} = \frac{α {D}_{k} \times {D}_{k} \times M \times β {D}_{f} + {α}^{2} M \times N \times β {D}_{f} \times β {D}_{f}}{{D}_{k} \times {D}_{k} \times M \times N \times {D}_{f} \times {D}_{f}} = \frac{{αβ}^{2}}{N} + \frac{{α}^{2} {β}^{2}}{{D}_{k}^{2}} ; \qquad ( 1 )$$

where C₁ denotes the amount of calculation of the standard convolution, C₂ denotes the amount of calculation of the depth separable convolution, α denotes the width factor of controlling the number of feature channels, which is usually 0.25, 0.5, 0.75 or 1; β denotes the resolution factor of controlling the feature resolution, which is usually 4/7, 5/7, 6/7 or 1.

It can be seen from the expression of the ratio of the amount of calculation between the depth-separable convolution and the standard convolution that, compared with the standard convolution, one-time depth-separable convolution can save the amount of calculation by

$$\frac{{αβ}^{2}}{N} + \frac{{α}^{2} {β}^{2}}{{D}^{2}} .$$

Moreover, the width factor and the resolution factor are adjusted, so that the number of parameters and the amount of calculation of the lightweight convolutional neural network MobileNetV3 can be further reduced.

The linear bottleneck structure first uses pointwise convolution to increase the dimension, uses the deep convolution to extract features, uses the channel attention mechanism module to accurately model the relationship between channels of convolution features, and uses the pointwise convolution to reduce the dimension in sequence. Finally, the linear activation function is used to reduce the feature loss, and the reverse residual structure is applied to the linear bottleneck structure, which can fully improve the search ability of the lightweight convolutional neural network MobileNetV3 with almost no increase in the number of parameters and the amount of calculation.

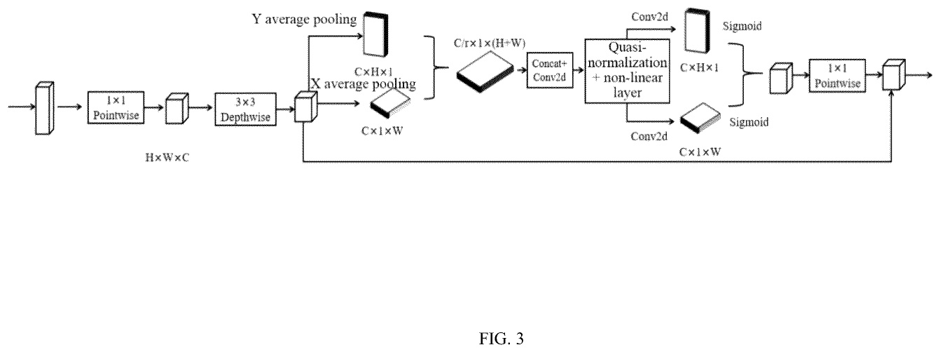

Step 3.2: a Coordinate Attention Mechanism (CA) module is embedded in the lightweight convolutional neural network MobileNetV3, as shown in FIG. 3.

A Coordinate Attention Mechanism (CA) module is embedded in the lightweight convolutional neural network MobileNetV3, and an input feature map is expanded by the Coordinate Attention Mechanism (CA) module to obtain an output feature map with expanded spatial information.

In the lightweight convolutional neural network MobileNetV3, the Coordinate Attention Mechanism (CA) module is embedded to fuse accurate spatial information. This method does not directly improve the original Squeeze and Excitation (SE) module of the lightweight convolutional neural network MobileNetV3 on the spatial scale, but proposes a new attention mechanism to enhance the spatial perception ability of the lightweight convolutional neural network MobileNetV3.

The specific steps of expanding an input feature map by the Coordinate Attention Mechanism (CA) module to obtain an output feature map with expanded spatial information are as follows.

(1) pooling is performed in a horizontal direction and a vertical direction of the input feature map, respectively, to obtain one-dimensional perceptual attention feature maps in the X direction and in the Y direction.

It is assumed that C, H and W are the channel number, the height and the width of the input feature map, respectively.

The global average pooling formula of the original Squeeze and Excitation (SE) module of the lightweight convolutional neural network MobileNetV3 is decomposed to obtain the features in the X direction and in the Y direction, and use the features in the X direction and in the Y direction to generate two one-dimensional perceptual attention feature maps, which represent the feature importance in the horizontal direction and in the vertical direction, respectively.

The global average pooling expression is expressed as:

$${Z}_{c} = \frac{1}{H \times W} {\sum }_{i = 1}^{H} {\sum }_{j = 1}^{W} {x}_{c} ( i , j ) ; \qquad ( 2 )$$

where Z_{c} denotes the output of the c-th channel, X_{c} denotes the two-dimensional feature set of the c-th channel, i and j denote the abscissa and the ordinate on the output features, respectively.

The expression of the one-dimensional perceptual attention feature map in the Y direction is:

$${Z}_{c}^{h} = \frac{1}{W} {\sum }_{0 \leq i \leq W} {x}_{c} ( h , i ) ; \qquad ( 3 )$$

where Z_{c}^{h} denotes the output of the c-th channel with a height of h, x_{c} denotes a two-dimensional feature set of the c-th channel, i denotes the abscissa on the output feature, and h denotes the specific coordinate of the c-th channel in the height direction.

The expression of the one-dimensional perceptual attention feature map in the X direction is:

$${Z}_{c}^{w} = \frac{1}{H} {\sum }_{0 \leq j \leq H} {x}_{c} ( j , w ) ; \qquad ( 4 )$$

where Z_{c}^{w} denotes the output of the c-th channel with a width of w, x_{c} denotes a two-dimensional feature set of the c-th channel, j denotes the ordinate on the output feature, and w denotes the specific coordinate of the c-th channel in the width direction.

(2) after cascading the perceptual attention feature maps in the X direction and in the Y direction, the perceptual attention feature maps are input into a 1×1 convolution F for transformation to generate an intermediate feature map o containing spatial information in the horizontal direction and in the vertical direction.

$$o = \partial ( F ( [ {z}^{h} , {z}^{w} ] ) ) ; \qquad ( 5 )$$

where [ ] denotes spatial dimension stitching operation, ∂ denotes a nonlinear activation function, F denotes the 1×1 convolution operation, Z^{h} denotes a one-dimensional feature map in the height direction, z_{w} denotes a one-dimensional feature map in the width direction, o denotes an intermediate feature map containing spatial information in the horizontal direction and in the vertical direction, o∈R^{C/r×(H+W)×1}; where C denotes the number of channels, and r denotes a hyper-parameter of controlling the size of the module.

(3) the intermediate feature map o is decomposed into a tensor o^{h}∈R^{C/r×H×1} and a tensor o^{w}∈R^{C/r×1×W} along a spatial dimension, and then a tensor o^{h} and a tensor o^{w} are transformed into a tensor with the same number of channels as the input features by using two 1×1 convolutions Fₕ and F_{w}, and a two-dimensional attention map is obtained.

$${g}^{h} = σ ( {F}_{h} ( {o}^{h} ) ) ; \qquad ( 6 )$$

$${g}^{w} = σ ( {F}_{w} ( {o}^{w} ) ) ; \qquad ( 7 )$$

where σ is a Sigmoid function, g^{h} denotes the attention vector obtained by performing Fₕ transformation of 1×1 convolution on the tensor o^{h}, g^{h}∈R^{C×H×1}, g^{w} denotes the attention vector obtained by performing F_{w} transformation of 1×1 convolution transformation on the tensor o^{w}, g^{w}∈R^{C×1×W}.

The generated two-dimensional attention map not only takes into account the feature recalibration between channels, but also fuses the precise spatial position information.

(4) the two-dimensional attention map is expanded to obtain an output feature with expanded spatial information.

$${y}_{c ( i , j )} = {x}_{c} ( i , j ) \times {g}_{c}^{h} ( i ) \times {g}_{c}^{w} ( j ) ; \qquad ( 8 )$$

where y_{c(i,j)} denotes a value of the output feature map in a channel c with position (i, j), x_{c}(i,j) denotes a value of the input feature map in the channel c with position (i, j), g_{c}^{h}(i) denotes an attention weight of an attention vector g^{h} in the h channel c in a horizontal position i, and g_{c}^{w}(j) denotes an attention weight of an attention vector g^{w} in the channel c in a vertical position j.

Through the above steps, not only a new attention mechanism is introduced into the lightweight convolutional neural network MobileNetV3, but also the spatial information is captured and fused precisely.

Step 3.3: a small target detection layer and a Squeeze and Excitation (SE) module are added at a neck end of the yolov8 network.

This embodiment accepts an input image of 640×640 pixels.

However, the unimproved yolov8 network cannot accurately identify the feature information of the target whose height and width are less than 8 pixels. Therefore, according to the present disclosure, by adding a small target detection layer, that is, adding a detection feature map with pixels of 160×160 in the unimproved yolov8 network, the improved yolov8 network can pay more attention to the detection of small target road cracks and improve the detection effect.

The specific step of adding a small target detection layer and a Squeeze and Excitation (SE) module at a neck end of the yolov8 network is as follows:
(1) reserving the PAN-FPN structure at the neck end of the yolov8 network, and adding a Squeeze and Excitation (SE) module after the upsample structure at the neck end to cooperate with the added small target detection layer;
(2) accumulating the 80×80 scale feature layer at a feature extraction network backbone end and the upsample feature layer at the neck end, and obtaining fused feature maps of feature information at different scales and different levels;
(3) performing a convolution module C2f, a Squeeze and Excitation (SE) module and an upsample operation on the fused feature maps of feature information at different scales and different levels to obtain a deep semantic feature layer containing small target feature information;
(4) accumulating the deep semantic feature layer containing small target feature information and a shallow position feature layer in the feature extraction network backbone to obtain a feature representation containing rich semantic information and precise position information;
(5) adding an extra decoupling header at the head end of the yolov8 network as a small target detection layer for detecting small targets.

When in use, the feature representation containing rich semantic information and precise position information is input into the small target detection layer for detection.

Step 3.3: a loss function of power IoU is introduced into a head prediction structure of the yolov8 network to replace a bounding box regression loss function bbox_loss.

In the original head prediction structure of the yolov8 network, several different loss functions are used to calculate the bounding box loss: an IoU loss function, a GIoU loss function, a DIoU loss function, and a CIoU loss function. Although the loss functions are obviously superior to the traditional IoU loss function used alone in many aspects, there are still some shortcomings and limitations.

In this embodiment, a loss function of power IoU is introduced into a head prediction structure of the yolov8 network to replace a bounding box regression loss function bbox_loss, where α=3. The power IoU loss function performs uniform exponentiation on the existing loss functions in the yolov8 by introducing the parameter α, so as to adjust the sensitivity of the bounding box to different overlapping degrees, which has stronger robustness.

The power IoU loss function includes an improved IoU loss function α-IoU, an improved GIoU loss function α-GIoU, an improved DIoU loss function α-DIoU and an improved CIoU loss function α-CIoU.

The method of calculating the IoU loss function is expressed as:

$${Loss}_{IOU} = 1 - IOU ; \qquad ( 9 )$$

where LOSS_{IoU} denotes the loss of the IoU loss function, and IoU denotes the area where the predicted box is intersected with the real box divided by the area where the predicted box is merged with the real box.

The method of calculating the improved IoU loss function a-IoU is expressed as:

$${Loss}_{α - IOU} = 1 - {IOU}^{α} ; \qquad ( 10 )$$

where LOSS_{α-IoU} denotes the loss of the improved IoU loss function α-IoU, α denotes an area of a minimum enclosing rectangle of a real box and a predicted box, and IoU denotes the area where the predicted box is intersected with the real box divided by the area where the predicted box is merged with the real box.

The method of calculating the GIoU loss function is expressed as:

$${Loss}_{GIOU} = 1 - IOU + \frac{a - u}{a} ; \qquad ( 11 )$$

where LOSS_{GIOU} denotes the loss of the GIoU loss function, α denotes an area of a minimum enclosing rectangle of a real box and a predicted box, u denotes the union area of the real box and the predicted box, and IoU denotes the area where the predicted box is intersected with the real box divided by the area where the predicted box is merged with the real box.

The method of calculating the improved GIoU loss function α-GIoU is expressed as:

$${Loss}_{α - GIOU} = 1 - {IOU}^{α} + {( \frac{a - u}{a} )}^{α} ; \qquad ( 12 )$$

where LOSS_{α-GIoU} denotes the loss of the improved GIoU loss function α-GIoU, α denotes an area of a minimum enclosing rectangle of a real box and a predicted box, u denotes the union area of the real box and the predicted box, and IoU denotes the area where the predicted box is intersected with the real box divided by the area where the predicted box is merged with the real box.

The method of calculating the DIoU loss function is expressed as:

$${Loss}_{DIOU} = 1 - IOU + \frac{{ρ}^{2} ( b , {b}^{gt} )}{{l}^{2}} ; \qquad ( 13 )$$

where LOSS_{DIOU} denotes the loss of the DIoU loss function, IoU denotes the area where the predicted box is intersected with the real box divided by the area where the predicted box is merged with the real box, b and b^{gt} denote the coordinates of the center points of the predicted box and the real box, respectively, ρ²(b, b^{gt}) denotes the Euclidean distance between the two center points, and l denotes the diagonal length of the minimum enclosing rectangle of the two boxes.

The method of calculating the improved DIoU loss function α-DIoU is expressed as:

$${Loss}_{α - D I O U} = 1 - {IOU}^{α} + \frac{{ρ}^{2 α} ( b , {b}^{gt} )}{{l}^{2 α}} ; \qquad ( 14 )$$

where LOSS_{α-DIOU} denotes the loss of the improved DIoU loss function, α denotes an area of a minimum enclosing rectangle of a real box and a predicted box, IoU denotes the area where the predicted box is intersected with the real box divided by the area where the predicted box is merged with the real box, b and b^{gt} denote the coordinates of the center points of the predicted box and the real box, respectively, ρ²(b,b^{gt}) denotes the Euclidean distance between the two center points (that is, the distance between two points in Euclidean space), and l denotes the diagonal length of the minimum enclosing rectangle of the two boxes.

The method of calculating the CIoU loss function is expressed as:

$${Loss}_{CIOU} = 1 - IOU + \frac{{ρ}^{2} ( b , {b}^{gt} )}{{l}^{2}} + βv ; \qquad ( 15 )$$

where LOSS_{CIOU} denotes the loss of the improved CIoU loss function, IoU denotes the area where the predicted box is intersected with the real box divided by the area where the predicted box is merged with the real box, b and b^{gt} denote the coordinates of the center points of the predicted box and the real box, respectively, ρ²(b,b^{gt}) denotes the Euclidean distance between the two center points (that is, the distance between two points in Euclidean space), l denotes the diagonal length of the minimum enclosing rectangle of the two boxes, β denotes the weight function, and ν denotes the similarity of the aspect ratio.

The method of calculating the improved CIoU loss function α-CIoU is expressed as:

$${Loss}_{α - CIOU} = 1 - {IOU}^{α} + \frac{{ρ}^{2 α} ( b , {b}^{gt} )}{{l}^{2 α}} + {( β ν )}^{α} ; \qquad ( 16 )$$

where LOSS α-CIoU denotes the loss of the improved CIoU loss function α-CIoU, α denotes an area of a minimum enclosing rectangle of a real box and a predicted box, IoU denotes the area where the predicted box is intersected with the real box divided by the area where the predicted box is merged with the real box, b and b^{gt} denote the coordinates of the center points of the predicted box and the real box, respectively, ρ²(b,b^{gt}) denotes the Euclidean distance between the two center points, l denotes the diagonal length of the minimum enclosing rectangle of the two boxes, β denotes the weight function, and V denotes the similarity of the aspect ratio.

β denotes the weight function, and the formula of calculating the weight function β is expressed as:

$$v = \frac{4}{{π}^{2}} ( arctan \frac{{width}^{gt}}{{height}^{gt}} - arctan \frac{width}{height} ) ; \qquad ( 17 )$$

where ν denotes the similarity of the aspect ratio, and the formula of calculating the similarity ν of the aspect ratio is expressed as:

$$β = \frac{v}{( 1 - IoU ) + v} ; \qquad ( 18 )$$

where width^{gt}, height^{gt}, width and height denote the width and the height of the real box and the predicted box, respectively.

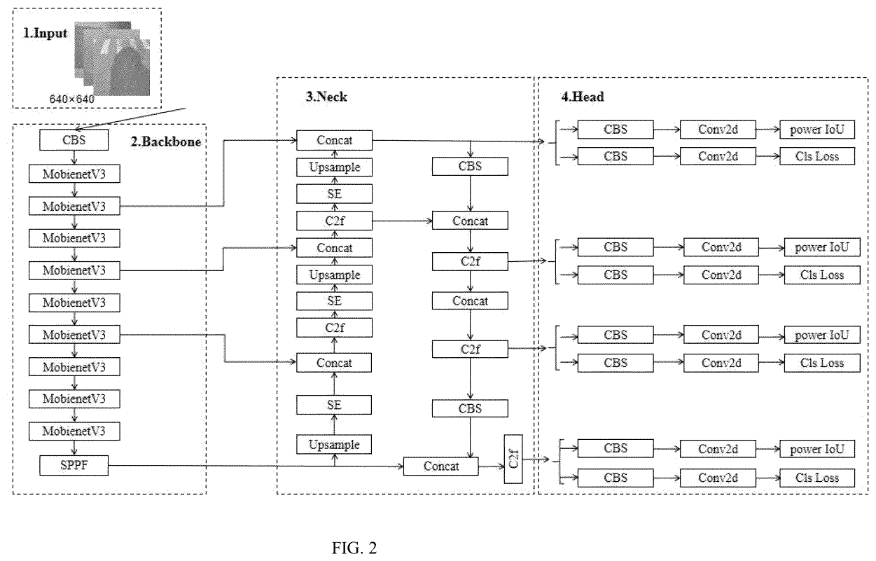

The network architecture of the lightweight YOLO-MCS road crack detection model is constructed, as shown in FIG. 2.

Step 4: the preprocessed training set is used to train the lightweight YOLO-MCS road crack detection model.

The steps of training the lightweight YOLO-MCS road crack detection model are as follows.

(1) the training parameters are set.

An optimizer is set based on Stochastic Gradient Descent (SGD): the momentum is set to 0.9, the initial learning rate is set to 0.01, the batch size is set to 32, and the number of training epochs is set to 200.

(2) the training set is used to train the lightweight YOLO-MCS road crack detection model. In each training iteration, the loss is calculated, and the weight of the lightweight YOLO-MCS road crack detection model is updated.

(3) at the end of each training cycle, the preprocessed verification set is used to evaluate the performance of the lightweight YOLO-MCS road crack detection model. The indicators such as the loss and the accuracy rate on the verification set are monitored, so as to stop training in time and prevent over-fitting.

Step 5: the preprocessed verification set is used to evaluate and optimize the trained lightweight YOLO-MCS road crack detection model.

In this embodiment, the lightweight YOLO-MCS road crack detection model is evaluated by two indicators: number of parameters and the amount of calculation.

The number of parameters determines the storage space required by the lightweight YOLO-MCS road crack detection model in unit of M.

The amount of calculation is described by Floating Point Operations (FLOPs). The amount of calculation determines the reasoning speed of the lightweight YOLO-MCS road crack detection model in unit of M in the case that the hardware device is determined.

In this embodiment, the performance of the lightweight YOLO-MCS road crack detection model is evaluated by accuracy, precision, recall, and F1-score.

The expression of calculating the accuracy is:

$$A = \frac{TP + TN}{TP + TN + FP + FN} ; \qquad ( 19 )$$

The expression of calculating the precision is:

$$P = \frac{TP}{TP + FP} ; \qquad ( 20 )$$

The expression of calculating the recall is:

$$R = \frac{TP}{TP + FN} ; \qquad ( 21 )$$

The expression of calculating the F1-score is:

$$F 1 = \frac{P \times R}{P + R} \times 2 ; \qquad ( 22 )$$

where A denotes the proportion of samples which are correctly predicted to be cracks in all predicted samples, P denotes the proportion of samples which are actually predicted to be cracks in all samples which are predicted to be cracks, R denotes the proportion of samples which are correctly predicted to be cracks by the model in all samples which are actually cracks, and F1 denotes the harmonic average of the precision and the recall, which is used to weigh the precision and the recall. TP denotes the number of positive samples predicted to be road cracks, FP denotes the number of positive samples predicted to have no cracks, FN denotes the number of negative samples predicted to have no cracks, and TN denotes the number of positive samples predicted to be road cracks.

When the performance of the lightweight YOLO-MCS road crack detection model does not meet expectations, the performance of the lightweight YOLO-MCS road crack detection model is improved by adjusting hyper-parameters such as the learning rate, the batch size and the training times. Some data enhancement methods are added to improve the diversity of data. By collecting a large number of training samples, the generalization ability of the lightweight YOLO-MCS road crack detection model is improved. In order to avoid the local optimum, different weight initialization strategies can also be used.

On this basis, the lightweight YOLO-MCS road crack detection model is trained and evaluated again. Repeat the above process until the lightweight YOLO-MCS road crack detection model reaches a satisfactory performance level.

Step 6: the road crack image containing transverse cracks, longitudinal cracks, crocodile cracks and road potholes is input into the optimized lightweight YOLO-MCS road crack detection model to obtain a road crack detection result.

### Embodiment 3

The present disclosure provides a computer-readable storage medium, on which a computer program/instruction is stored, wherein the computer program/instruction, when executed by a processor, implements the steps of the method in Embodiment 1 or 2 described above.

### Embodiment 4

The present disclosure further provides a computer program product, including a computer instruction, wherein the computer instruction, when executed by a processor, implements the steps of the method n Embodiment 1 or 2 described above.

To sum up, the lightweight YOLO-MCS road crack detection model proposed by the present disclosure significantly reduces the amount of calculation and the number of network parameters required for detecting road cracks, and enhances the ability to extract the features of small target road cracks, so that road cracks can be detected and identified efficiently and accurately, and the problems that the existing road cracks have diverse shapes and have low differentiation from road surface texture and it is difficult for the existing detection algorithms to be applied to edge devices with limited computing resources are overcome.

Aiming at the problems that the road cracks have diverse shapes and have low differentiation from road surface texture and it is difficult for the existing detection algorithms to be applied to edge devices with limited computing resources, the present disclosure provides a lightweight YOLO-MCS road crack detection model. Based on the yolov8 algorithm, the improved lightweight network MobileNetV3 is used as the backbone network to extract image features, and is combined with the depth separable convolution, the inverse residual structure and the Coordinate Attention Mechanism (CA) module to reduce the number of parameters and the amount of calculation while ensuring precision. A small target detection layer is added to the network framework. At the same time, the Squeeze and Excitation (SE) module and the α-IoU loss function are introduced to further improve the detection precision of small targets such as small cracks. The road crack detection method provided by the present disclosure can significantly improve the detection robustness of road cracks, and enhance the ability of the model to extract the features of small target road cracks, so that road cracks can be detected and identified efficiently and accurately. At the same time, the method has a small amount of calculation and a small number of parameters, and has wide applicability, which can be applied to most edge devices for road crack detection.

It should be understood by those skilled in the art that the embodiment of the present disclosure can be provided as a method, a system, or a computer program product. Therefore, the present disclosure can take the form of an entirely hardware embodiment, an entirely software embodiment, or an embodiment combining software and hardware aspects. Moreover, the present disclosure can take the form of a computer program product implemented on one or more computer-usable storage media (including but not limited to a disk storage, a CD-ROM, an optical storage, etc.) containing computer-usable program codes.

The present disclosure is described with reference to flow charts and/or block diagrams of a method, a device (a system), and a computer program product according to the embodiment of the present disclosure. It should be understood that each flow and/or block in the flow chart and/or block diagram, and combinations of the flows and/or blocks in the flow chart and/or block diagram can be implemented by computer program instructions. These computer program instructions may be provided to a processor of a general-purpose computer, a special-purpose computer, an embedded processor or other programmable data processing devices to produce a machine, so that the instructions which are executed by the processor of the computer or other programmable data processing devices produce an apparatus for implementing the functions specified in one or more flows in the flow chart and/or one or more blocks in the block diagram.

These computer program instructions may also be stored in a computer-readable memory that can direct a computer or other programmable data processing devices to function in a particular manner, so that the instructions stored in the computer-readable memory produce an article of manufacture including an instruction apparatus. The instruction apparatus implements the functions specified in one or more flows in the flow chart and/or one or more blocks in the block diagram.

These computer program instructions may also be loaded onto a computer or other programmable data processing devices, so that a series of operation steps are performed on the computer or other programmable devices to produce a computer-implemented process, so that the instructions executed on the computer or other programmable devices provide steps for implementing the functions specified in one or more flows in the flow chart and/or one or more blocks in the block diagram.

The embodiments of the present disclosure have been described above with reference to the attached drawings, but the present disclosure is not limited to the above detailed description. The above detailed description are only schematic, rather than restrictive. When being inspired by the present disclosure, those skilled in the art can make many forms without departing from the spirit of the present disclosure and the scope of protection the claims, which are all within the protection of the present disclosure.

What is claimed is:

1. A road crack detection method, comprising:
acquiring a road crack image to be detected;
inputting the road crack image into a pre-trained lightweight You Only Look Once (YOLO)-MCS road crack detection model to obtain a road crack detection result;
wherein the lightweight YOLO-MCS road crack detection model is constructed based on an improved yolov8 network;
a method of improving the yolov8 network comprises:
replacing a feature extraction network backbone of the yolov8 network with a lightweight convolutional neural network MobileNetV3, and embedding a Coordinate Attention Mechanism (CA) module in the lightweight convolutional neural network MobileNetV3;
adding a small target detection layer and a Squeeze and Excitation (SE) module at a neck end of the yolov8 network;
introducing a loss function of power Intersection over Union (IoU) into a head prediction structure of the yolov8 network to replace a bounding box regression loss function bbox_loss.

2. The road crack detection method according to claim 1, wherein prior to inputting a road crack data set into the pre-trained lightweight YOLO-MCS road crack detection model, a data preprocessing operation needs to be performed on the road crack data set.

3. The road crack detection method according to claim 2, wherein the specific step of performing data preprocessing operation on the road crack data set comprises:
filtering road crack images in the road crack data set to obtain a labeled picture data set containing four different road crack types;
reducing the application of default parameters of scale, mosaic, mixup and paste_in image enhancement methods, introducing shear and perspective image enhancement methods to perform image enhancement processing on the labeled picture data set containing four different road crack types, and obtaining the road crack data set after image enhancement;
normalizing and standardizing the road crack data set after image enhancement to obtain the road crack data set after data scaling;
dividing the road crack data set after data scaling into a training set and a verification set randomly.

4. The road crack detection method according to claim 1, wherein a Coordinate Attention Mechanism (CA) module is embedded in the lightweight convolutional neural network MobileNetV3, and an input feature map is expanded by the Coordinate Attention Mechanism (CA) module to obtain an output feature map with expanded spatial information.

5. The road crack detection method according to claim 1, wherein the method of expanding an input feature map by the Coordinate Attention Mechanism (CA) module to obtain an output feature map with expanded spatial information comprises:
(1) performing pooling in a horizontal direction and a vertical direction of the input feature map, respectively, to obtain one-dimensional perceptual attention feature maps in the X direction and in the Y direction;
(2) after cascading the perceptual attention feature maps in the X direction and in the Y direction, inputting the perceptual attention feature maps into a 1×1 convolution F for transformation to generate an intermediate feature map o containing spatial information in the horizontal direction and in the vertical direction;
(3) decomposing the intermediate feature map o into a tensor o^{h}∈R^{C/r×H×1} and a tensor o^{w}∈R^{C/r×1×W} along a spatial dimension, and then transforming a tensor o′ and a tensor o^{w} into a tensor with the same number of channels as the input features by using two 1×1 convolutions Fₕ and F_{w}, and obtaining a two-dimensional attention map;
(4) expanding the two-dimensional attention map to obtain an output feature with expanded spatial information.

6. The road crack detection method according to claim 5, wherein the output feature with expanded spatial information are expressed as:
$${y}_{c ( i , j )} = {x}_{c} ( i , j ) \times {g}_{c}^{h} ( i ) \times {g}_{c}^{w} ( j ) ;$$
where y_{c(i,j)} denotes a value of the output feature map in a channel c with position (i, j), x_{c}(i, j) denotes a value of the input feature map in the channel c with position (i, j), g_{c}^{h}(i) denotes an attention weight of an attention vector h g^{h} in the channel c in a horizontal position i, and g_{c}^{w}(j) denotes an attention weight of an attention vector g^{w} in the channel c in a vertical position j.

7. The road crack detection method according to claim 1, wherein the method of adding a small target detection layer and a Squeeze and Excitation (SE) module at a neck end of the yolov8 network comprises:
(1) reserving the Path Aggregation Network with Feature Pyramid Network (PAN-FPN) structure at the neck end of the yolov8 network, and adding a Squeeze and Excitation (SE) module after the upsample structure at the neck end to cooperate with the added small target detection layer;
(2) accumulating the 80×80 scale feature layer at a feature extraction network backbone end and the upsample feature layer at the neck end, and obtaining fused feature maps of feature information at different scales and different levels;
(3) performing a convolution module C2f, a Squeeze and Excitation (SE) module and an upsample operation on the fused feature maps of feature information at different scales and different levels to obtain a deep semantic feature layer containing small target feature information;
(4) accumulating the deep semantic feature layer containing small target feature information and a shallow position feature layer in the feature extraction network backbone to obtain a feature representation containing semantic information and position information;
(5) adding an extra decoupling header at the head end of the yolov8 network as a small target detection layer for detecting small targets.

8. The road crack detection method according to claim 1, wherein the power IoU loss function performs uniform exponentiation on the existing loss functions in the yolov8 by introducing an area of a minimum enclosing rectangle of a real box and a predicted box as a parameter, and the power IoU loss function comprises an improved IoU loss function α-IoU, an improved GIoU loss function α-GIoU, an improved DIoU loss function α-DIoU and an improved CIoU loss function α-CIoU.

9. A computer-readable storage medium, on which a computer program/instruction is stored, wherein the computer program/instruction, when executed by a processor, implements the steps of the method according to claim 1.

10. A computer program product, comprising a computer program/instruction, wherein the computer program/instruction, when executed by a processor, implements the steps of the method according to claim 1.
